(19) United States
(12) Patent Application Publication
(10) Pub. No.: US 2007/0000393 A1
(43) Pub. Date: Jan. 4, 2007

(54) Electric grill

(76) Inventor: Raymond Hoi-Tak Lam, Wanchai (HK)

Correspondence Address: GALLAGHER & KENNEDY, P. A., 2575 E. CAMELBACK RD. #1100, PHOENIX, AZ, 85016, US

(21) Appl. No.: 11/441,992

(22) Filed: May 25, 2006

Related U.S. Application Data
(63) Continuation-in-part of application No. 29/216,943, filed on Nov. 10, 2004.
(60) Provisional application No. 60/779,944, filed on Mar. 7, 2006.

(51) Int. Cl. A47J 37/06

(52) U.S. Cl. 99/372

(57) ABSTRACT

An electric grill for use to create healthier meals is disclosed. The electric grill comprises a support structure which holds a top heating section and a bottom heating section connected by a hinge. The hinge allows for a wide range of movement whereby the top heating section may be face to face with the bottom heating section, may be perpendicular, or may be at a 180 degree angle. Moreover, the top and bottom heating sections may be tilted such that excess grease, oils and juices may be separated from the food being cooked. The electric grill disclosed herein also may include a digital read-out display and a user input keypad.

### CROSS REFERENCE

This application is a Continuation-in-Part of the U.S. design patent application Ser. No. 29/216,943 filed Nov. 10, 2004 in the name of Raymond (Hoi-Tak) Lam and entitled “Electric Grill.” That application is incorporated herein by reference. This application is a Continuation-in-Part of the U.S. utility patent application of Raymond (Hoi-Tak) Lam filed May 24, 2006, entitled “Electric Grill,” Serial No. not yet assigned. This present application claims the benefit of U.S. Provisional Patent Application 60/779,944, titled TILTABLE PANINI GRILL, filed on Mar. 7, 2006. The disclosure of said application is incorporated by reference herein.

### BACKGROUND OF THE INVENTION

The present invention relates to electric grills which are commonly used to create more healthy meals. Grills of this type commonly separate excess oils and juices from the food being prepared, such that the cooked food has a lower fat and cholesterol content.

Many such grills are well known in the art. These grills typically include a bottom heating surface and an upper heating surface which, when an electric current is introduced, become hot enough to cook various types of food. The top and bottom heating surfaces are commonly connected using a hinge. The food usually rests on the bottom heating surface while the top heating surface, facing the bottom heating surface, is placed on top of the food. The food is thereby cooked on both sides simultaneously, which cuts down on cooking time.

However, an all too common problem occurs when cooking larger food because the top heating surface cannot remain parallel to the bottom heating surface. As a result, the food is cooked unevenly because it is being pinched on one side by the misaligned top heating surface.

The grills that attempt to resolve this require the use of springs, or other extraneous techniques and mechanisms, to create a cumbersome and complicated cooking system. Moreover, these past solutions limit movement of the top cooking surface, and thus still create problems when cooking larger food. Additionally, these techniques and systems further limit the various methods of cooking possible on the electric grill.

Other types of electric grills allow for the bottom heating surfaces to be on an angle. An angled bottom heating surface allows excess grease, oils and juices to separate from the food being prepared, thus creating a healthier meal. The bottom heating surface, as well as the top heating surface, is usually fixed at a pre-determined angle, or may be limited to adjust to only two or three pre-specified angles. The constraint on the possible cooking angles severely limits the use of the electric grill.

Most, if not all, of the electric grills are designed such that the top heating surface is attached to the bottom heating surface using a hinge. Thus, the top heating surface can be raised to be perpendicular to the bottom heating surface. This feature allows the user to easily position the food on the bottom heating surface. In effect, the top heating surface acts only as a secondary cooking surface. Therefore, if the user desires to cook only one side of the food, the top heating surface remains in its perpendicular position and is left unused.

Commonly, when the top heating surface is left in the perpendicular position, the top heating surface is still using electricity and is still creating heat. There is no way to regulate the temperature of the top and bottom heating surfaces individually.

Other electric grills comprise a manual control such as a cooking timer. The cooking timer usually incorporates a large manual dial or knob which the user can manually set.

Despite the electric grills currently in use, there remains a need for a simple and efficient electric grill with improved features.

Indoor electric grills are extremely popular with consumers and there are many models commercially available on the market. Due to their popularity, there is a continuing need for indoor electric grills which allow for improved cooking of meats and other foods.

It has been recognized for some time that it is desirable to cook foods in electric grills in a manner that allows fat and other juices produced during the cooking process to be removed. Therefore, electric grills have been designed to allow the fat and other juices to drain from the grill during the cooking process where they are collected in a container. For example, electric grills have been designed with a downwardly sloping lower cooking surface that leads the fat and other juices to a collection mechanism or drip tray. Other grills have been designed with drip holes within the lower cooking surface into which the fat and other juices drain and are led to a collection mechanism or drip tray. Examples of these typical prior art electric grills are disclosed in U.S. Pat. Nos. 4,173,179; 5,546,851; 5,606,905; and 6,526,873.

Some people, for health reasons, desire the fat and other juices created during the cooking process to be almost entirely removed. However, the more fat and juices removed during the cooking process, the drier the resulting food will be. Others desire some of the fat and juices created during the cooking process to remain with the food, resulting in a moist, juicy food. Moreover, a person may desire varying amounts of fat and juices to drain from the food being cooked depending on the fat content of the particular food. The disadvantage of the prior art grills is that these grills do not allow a person to vary the amount of fat and juices removed during the cooking process according to individual preference or to achieve varying results for different meats cooked in the grills. Another disadvantage of prior art grills is that the cooking chamber is typically fixed in size and volume. Therefore, the thickness of foods that may be cooked in the grill is limited.

U.S. Pat. No. 4,173,179 discloses an electric cooking device composed of two heating plates and a drip tray that functions both as a supporting and storage vessel. The drip tray collects the fat and other juices from food during the cooking process and holds the cooking device in place during cooking. The drip tray can hold the cooking device in one of two positions, either horizontally or vertically.

U.S. Pat. No. 5,546,851 discloses an electric cooking apparatus composed of a cooking plate having a plurality of drip holes that allow cooking juices to drain from the cooking plate during cooking and into a receiving pan. The receiving pan supports the cooking plate and collects the cooking juices. The apparatus sits on a counter or tabletop in a horizontal position only.

U.S. Pat. No. 5,606,905 discloses an electrical cooking device composed of a lower cooking plate and an upper cooking plate movable relative to the lower cooking plate to a closed position in which the upper and lower cooking plates form a cooking chamber. The lower cooking plate is positioned at an angle to the horizontal plane of the cooking device and includes at least one downwardly extending portion into which liquid emitted by foods during the cooking process within the cooking chamber are directed. This cooking device also sits on a counter or tabletop in a horizontal position only.

U.S. Pat. No. 6,526,873 discloses an electric cooking appliance comprising a lower cooking unit and an upper cooking unit pivotally mounted on the lower cooking unit for rotation substantially about a horizontal axis into three different positions. The upper cooking unit alone can be rotated into a first position in which the upper cooking unit is on top of the lower cooking unit, a second position in which the upper cooking unit is substantially horizontal with and parallel to the lower cooking unit, and a third, generally upright position intermediate the first and second positions. When the upper cooking unit is positioned on top of the lower cooking unit, the assembly forms a closed chamber or contact grill. In the other positions, the cooking units do not form a chamber and are used as griddles. Fat and other juices produced during the cooking process are guided away from the food and into a collection tray by sloping surfaces on the lower cooking unit.

It is an object of the present invention to provide an electric grill that allows the consumer to use a closed cooking chamber in several positions, thereby allowing the consumer to vary the amount of fat and other juices that runoff from various foods during the cooking process. It is a further object of the present invention to provide an electric grill with a cooking chamber that may vary in size and volume, allowing foods of varying thickness to be cooked in the grill.

### SUMMARY OF THE INVENTION

The present invention is a new type of electric grill comprised of a lower cooking assembly and an upper cooking assembly pivotally mounted on the lower cooking assembly for rotation about a substantially horizontal axis by means of a foldable hinge, the lower and upper cooking assemblies comprising between them a cooking chamber. The cooking chamber can be positioned at various angles relative to horizontal such that fat and other juices released from the food during the cooking process can drain in varying degrees into a drip tray located underneath the cooking chamber, allowing for different cooking results from extremely dry food to juicy food and in between. The size and volume of the cooking chamber can be varied to accommodate a wide range of foods by means of the foldable hinge.

An electric grill comprising a support structure having top and bottom heating sections is disclosed. The top heating section has a top cooking surface and the bottom heating section has a bottom cooking surface. The top and bottom heating sections are connected to the support structure and at least one section is pivotally associated with the support structure to move between a closed position at which the cooking surfaces are facing one another and an open position at which the surfaces are at an angle to one another that is equal to or greater than 90 degrees. In a closed position, the top heating section is preferably directly on top of and facing the bottom heating section, which lowers the required cooking time by cooking the food on two sides. Moreover, the top heating section may be in an open position such that the top heating section is perpendicular to the bottom heating section. This open position allows the user to easily place food on the bottom cooking surface, and can also be used to cook food only on one side. The top heating section may be opened to 180 degrees such that the top and bottom heating sections can both be used as a flat cooking surface on which food may be placed. The support structure preferably includes a tilting mechanism which supports the top and bottom heating sections in a plurality of angular positions.

The top and bottom heating sections may be maintained separate from one another, while in the closed position, at a distance such that food on the bottom cooking surface is not touched by the top cooking surface, or the top heating section may be lowered towards the bottom heating section so that food on the bottom cooking surface is touched by the top cooking surface.

An additional aspect of this invention may include an at least one hinge to which the top and bottom heating sections are connected and which allows the aforementioned pivoting. The hinge is preferably of the type that can float to accommodate various sizes of food. This allows the top heating section to always be in contact with the food by maintaining a parallel position as compared to the bottom heating section, when in the closed position. An electric grill that can maintain the top heating section parallel to the bottom heating section cooks the food more evenly over the entire surface of the food.

The top and bottom heating sections are more preferably hinged together by two hinges separated from one another which allow for grease, oils and juices from the food being cooked to drip off of the bottom heating section from between the two hinges. The hinges and tilting mechanism preferably attach to the top and bottom heating sections at the same point on both the top and bottom heating sections.

In a preferred embodiment, two tabs may be engaged to hold the top heating section in a position as high above the bottom heating section as possible. This setting, once the tabs are engaged, may create a broil-type cooking arrangement.

The tilting mechanism, in a preferred embodiment, comprises a gear allowing releasable fixation of the top and bottom heating sections at a number of discrete angular positions. The tilting mechanism is more preferably a gear-toothed wheel in conjunction with a rod which fits within two teeth of the gear-toothed wheel. When the rod engages the wheel the top and bottom heating surfaces are locked in place and when the rod is disengaged the combination of the top and bottom heating surfaces can move freely. The rod preferably engages and disengages the wheel by a user-operated push button. The series of gear teeth are preferably spaced to allow for fine adjustment, i.e. five degree increments. However, it is also anticipated that the tilting mechanism may allow for infinitely adjustable releasable fixation of the top and bottom heating sections. Holding handles located on the front of both the top and bottom heating sections, the button may be pushed by the user which removes the rod from the gear wheel. The heating sections, as a single unit, are then adjusted, by manually moving the top and bottom heating sections using the handles, to the desired angle and the button is released. Upon release of the button, the rod re-engages the gear wheel at the desired angle and locks the heating sections at the desired angle. The angular positioning can preferably adjust the top and bottom heating sections to an angle from 0 to 60 degrees.

A further aspect of the invention is a variety of cooking surfaces which attach to the top and bottom heating sections to enable the electric grill to operate in a variety of cooking uses. The cooking surfaces are removable, replaceable and washable. The top cooking surface may be the same as the bottom cooking surface. The top cooking surface may also be different from the bottom cooking surface, which is particularly useful when the electric grill is arranged such that the top heating section is at a 180 degree angle to the bottom heating section, thus creating two flat surfaces on which different types of cooking may occur at once. The variety of cooking surfaces includes, but is not limited to, grill plate, griddle plate, pancake plate, waffle plate, pizzelle plate, sauté plate, steam plate, crisper plate and warming plate.

Another aspect of a preferred embodiment of the invention is a digital read-out which may provide information such as cooking time, top heating section heat intensity and bottom heating section heat intensity. The digital read-out may have further functions such as pre-programmed cooking techniques and automatic settings for cooking time and top and bottom heating section heat intensities.

Moreover, the electric grill may preferably have a keypad which includes buttons to start and stop cooking, adjust the heat intensity of the top heating section, adjust the heat intensity of the bottom heating section and adjust cooking time.

Furthermore, the electric grill may preferably include a drip tray, heat shield, splatter guard and a cross member. The cross member is located on the base of the grill and provides additional stability.

### BRIEF DESCRIPTION OF THE DRAWINGS

FIG. 1 is a perspective view of the preferred embodiment.

FIG. 2 is an elevation view of the front of the electric grill.

FIG. 3 is a perspective view of the grill with a top heating surface in an open position pivoted away from a bottom heating surface.

FIG. 4 is a perspective view of the top heating surface at a 180 degree angle to the bottom heating surface.

FIG. 5 is an enlarged, exaggerated, fragmentary perspective view of the top heating surface interacting with the extendable tabs.

FIG. 6 is a perspective view of the electric grill utilizing the tilting mechanism.

FIG. 7 illustrates a cross section of the support structure, hinge component and tilting mechanism.

FIG. 8 is a perspective view of an electric grill in accordance with this invention shown in a closed condition at a position approximately five degrees (5°) relative to horizontal.

FIG. 9 is another perspective view of the grill in FIG. 1 shown in an open position with both the upper and lower cooking assemblies in a horizontal position providing a contact surface.

FIG. 10 is a right side view of the grill in FIG. 1 shown closed at two different positions, the first position being approximately five degrees (5°) relative to horizontal, and the second position being approximately seventy-five degrees (75°) relative to horizontal.

FIG. 11 is another perspective view of the grill in FIG. 1 shown closed and depicting the internal structure of a leg that supports the grill at varying positions relative to horizontal.

FIG. 12 is a front view of the grill in FIG. 1 shown closed, at a position approximately seventy-five degrees (75°) relative to horizontal.

FIG. 13 is a bottom view of the grill in FIG. 1 showing a drip tray.

FIG. 14 is a side elevation of the grill of FIGS. 8-13 expanded with upper and lower grilling surfaces spaced apart.

### DETAILED DESCRIPTION OF THE PREFERRED EMBODIMENT

In the following is described the embodiments of the electric grill which is the present invention. In describing the embodiments illustrated in the drawings, specific terminology will be used for the sake of clarity. However, the invention is not intended to be limited to the specific term so selected, and it is to be understood that each specific term includes all technical equivalents that operate in a similar manner to accomplish a similar purpose.

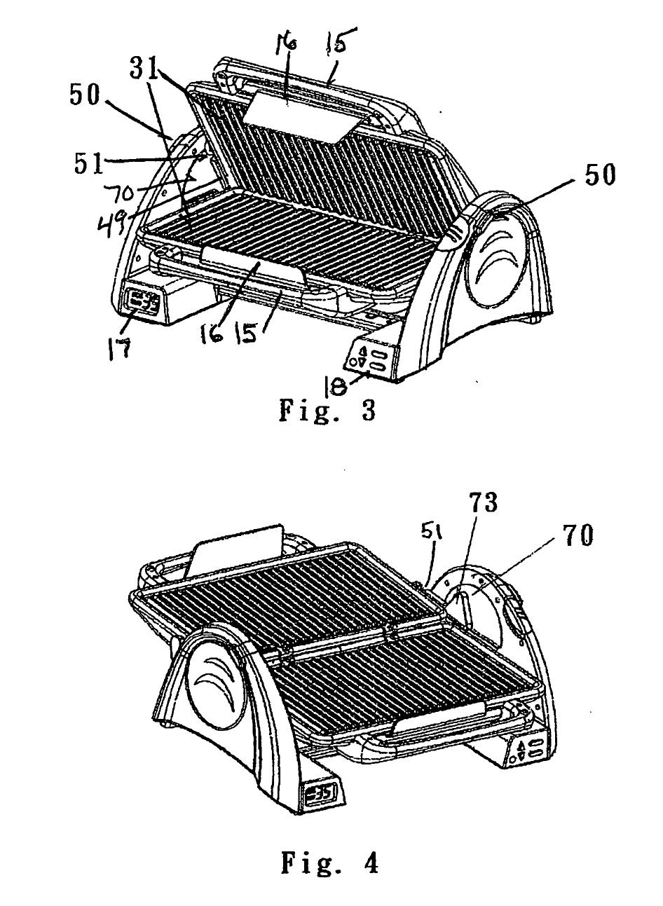

Referring to the figures, FIG. 1 depicts a perspective view of an electric grill in accordance with the preferred embodiment of the present invention. As shown, the electric grill 10 has a top heating section 11 and a bottom heating section 12 attached to a support structure 14 by two hinges 70. The hinges 70 attach to the rear portion of both the top and bottom heating sections 11 and 12 which allows the top heating section 11 to pivot on its rear side such that the top heating section 11 lifts up from the bottom heating section 12 to a position roughly perpendicular to the bottom heating section 12, as shown in FIG. 3. The top and bottom heating sections 11 and 12 each have a handle 15 on the front side to ease in handling by the user. Moreover, both top and bottom heating sections 11 and 12 include a splatter guard 16 on the front side to protect the user from hot grease, oils and juices which are released from the food during cooking. The support structure 14 preferably includes a digital read-out 17 and a user input keypad 18.

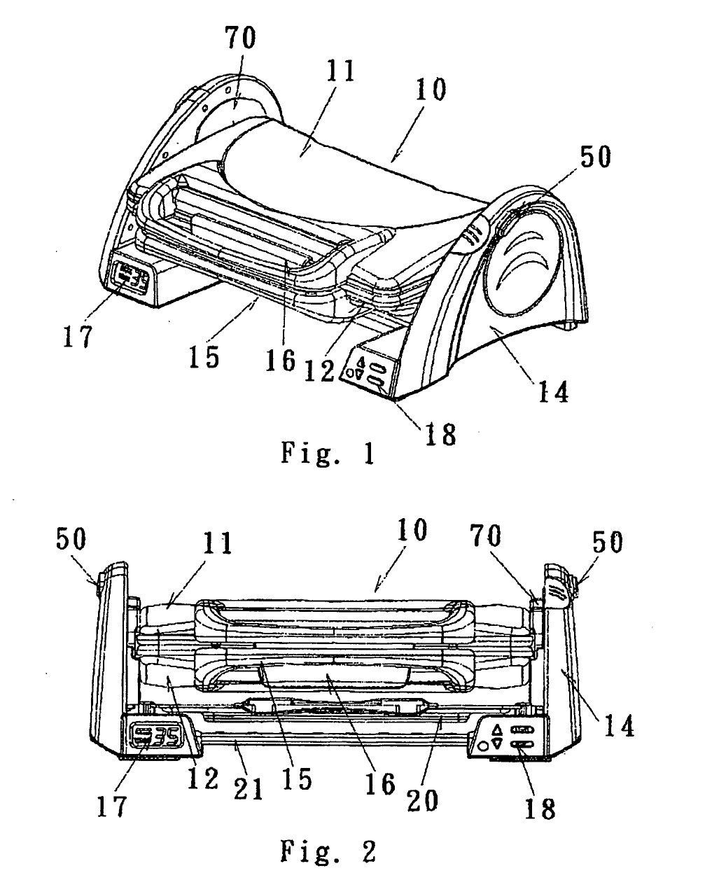

Furthermore, as seen in FIG. 2, the preferred embodiment of this invention includes a removable drip tray 20 which is located above a mid-beam 21 which offers additional support and stability to the support structure 14. The drip tray 20 collects excess grease, oils and juices which flow from the food and down the rear of the bottom heating section 12. The excess liquids then flow off the rear of the bottom heating section 12 and fall into the drip tray 20. The drip tray 20 is removable for ease of cleaning and is washable.

The electric grill 10 may be constructed from a variety of materials. Preferably, the electric grill will be constructed of plastic suitable to withstand the temperatures reached in and around an oven or grill. Other materials such as various metals and other composites may also be utilized. For example, a partial stainless steel exterior may be desirable to match the motif of a kitchen and the appliances therein. Also, the top and bottom heating sections 11 and 12 are preferably constructed of steel, and more preferably stainless steel. It is preferable that as much of the electric grill 10 should be made of plastic as possible as it is a benefit of the electric grill 10 of this invention that it remain light-weight and thus easily positioned and used on a solid surface, such as a counter-top or table. After use, the light-weight and compact structure allows the electric grill 10 to be easily stored in a cabinet or the like.

Attached to each of the top and bottom heating sections 11 and 12 is a cooking surface 31, which may be seen in FIG. 3. The cooking surface 31 is the surface on which the food is placed to cook. The cooking surfaces 31 are preferably constructed of material suitable and well known in the art for cooking food, such as steel, aluminum or other suitable materials. The cooking surface 31 may be clad with a non-stick coating, such as Teflon, to ease the cooking and cleaning process. Moreover, the heating plates 31 should be removable, washable and replaceable. It is intended that the electric grill 10 would include a variety of cooking surfaces 31 suitable for various types of cooking procedures. The variety of cooking surfaces 31 includes, but is not limited to, grill surface, griddle surface, pancake surface, waffle surface, pizzelle surface, sauté surface, steam surface, crisper surface and warming surface.

FIG. 3 shows how the hinge 70 preferably connects the top and bottom heating sections 11 and 12 to each other such that they can interact with one another. The hinge 70 is preferably constructed in a circular design. This circular design allows the hinge 70 to smoothly interact with the unique tilt mechanism 80, which will be discussed below with reference to FIG. 7. The bottom heating section 12 is affixed to the hinge 70 such that the bottom heating section 12 remains stationary. Again, as will be discussed below, this design allows the hinge 70 to smoothly interact with the tilt mechanism 80. The hinge 70 does not allow movement in the bottom heating section 12. But, when the hinge 70 is moved using the tilt mechanism 80, the bottom heating section 12 moves directly in sync with the hinge 70 and tilt mechanism 80 since they are all connected to each other to form one coherent and rigid structure.

As shown in FIG. 7, the top heating section 11 preferably has a peg 73 which extends from each rear corner. Each peg 73 inserts into each channel 72 on each hinge 70. The peg 73 is free to navigate up and down through the channel 72. For the sake of clarity, this peg-channel combination will be hereinafter referred to as a “floating hinge” 74.

The floating hinge 74 gives the top heating section 11 ample flexibility and movement in which to conduct various cooking operations. Moreover, the floating hinge design 74 of the present invention is simpler than those known in the art since the floating hinge 74 does not include extraneous parts, such as a spring or the like. The floating hinge 74, or at least the housing thereof, is preferably built of a plastic suitable to withstand the heat of a grill or oven.

The floating hinge design 74 of the present invention allows the top heating section 11 to operate in three distinct positions. First, as seen in FIG. 1, the top heating section 11 may be in a closed position such that it is face-to-face with the bottom heating section 12. This configuration results in a faster cooking time since food is cooked on two sides at once. Moreover, if the food is particularly large, the floating hinge 74 allows the rear end of the top heating section 11 to elevate, thus increasing the space between the rear portions of the top and bottom heating sections 11 and 12. The floating hinge allows the top heating section to elevate, in the preferred embodiment, to about 3 inches above the bottom heating section. As a result, the top heating section can remain parallel to the bottom heating section 12, even when larger sized food is cooked, and allow for even cooking over the entire surface of the food.

If the food being cooked is particularly small, the top heating section 11 may interact directly with the bottom heating section and “seal” the food in between the top and bottom heating sections 11 and 12. This is anticipated to be particularly useful, for example, when using a sautéing surface. The bottom heating section 12 has a sautéing surface affixed to it, and the top heating section is brought down to this first position to “seal” the sautéing food between the bottom heating section sauté surface and the top heating section 11. This traps in the heat and allows for faster sautéing of the food. Furthermore, the “seal” can also operate as a pressure cooker for use in certain cooking functions in which pressure cooking is desired. It is envisioned that a clamp or spring could be added to the top and bottom heating sections 11 and 12 to increase the pressure cooker capabilities by locking the top and bottom heating sections 11 and 12 together when in this position.

The second position, embodied in FIG. 3, is where the top heating section 11 is preferably roughly perpendicular to the bottom heating section 12. The top heating section 11 comes to rest at a preferably roughly perpendicular position and remains there without requiring support from the user. The top heating section 11 rests on the support structure 14. This is particularly useful when positioning food on the bottom heating section 12. Moreover, this position may be used when the user desires to only cook one side of the food at a time. As will be discussed in greater detail below, the user input keypad 18 allows the top heating section 11 to be turned completely off when the top heating section 11 is in this position, such that it is not hot and is not using electricity.

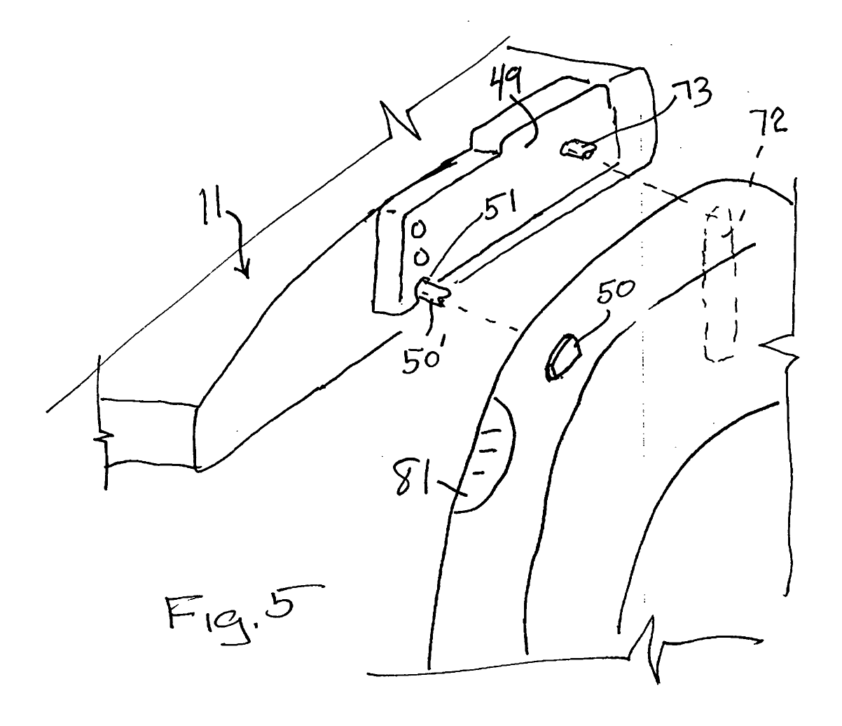

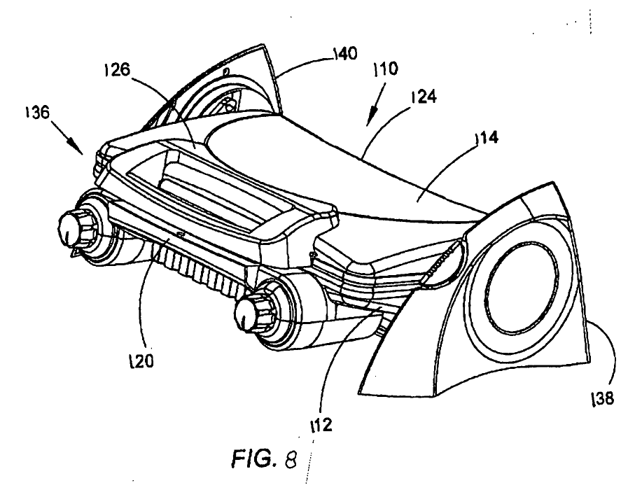

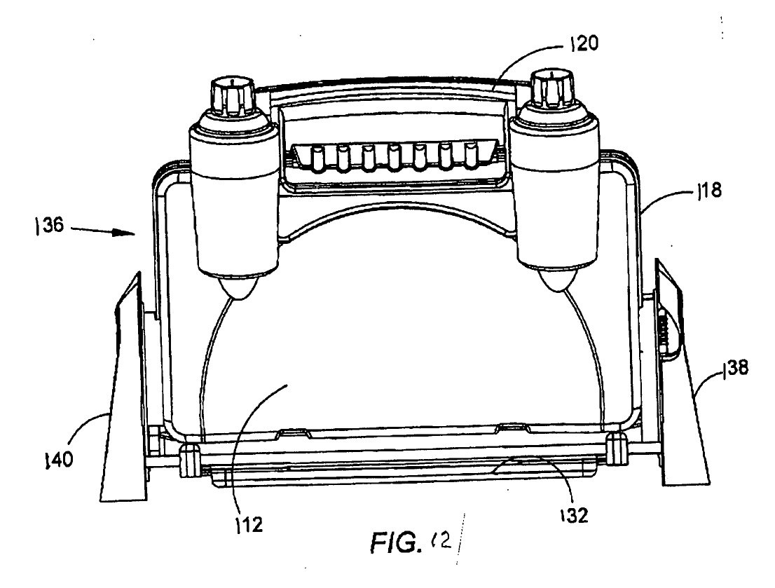

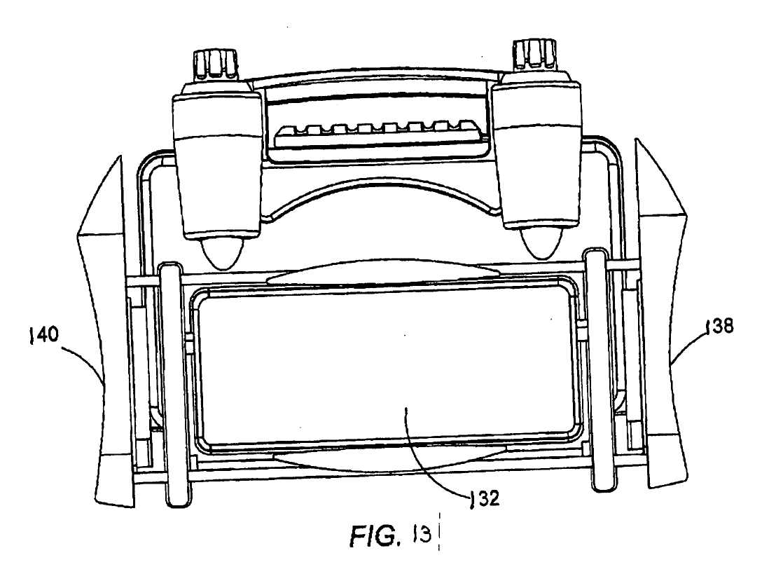

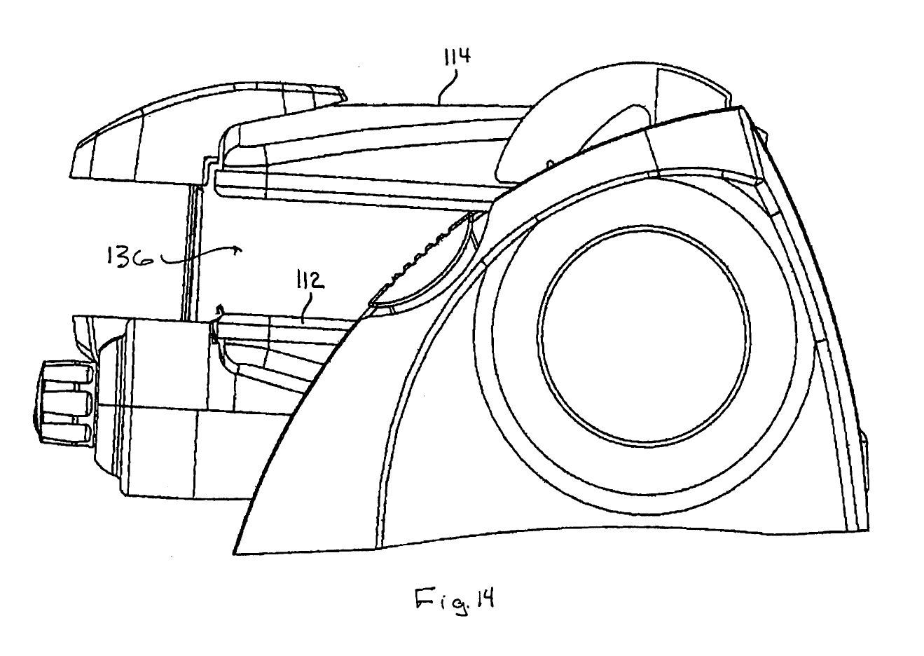

In a third possible position, illustrated in FIG. 4, the top heating section 11 may continue to be lifted towards the back of the electric grill 10 to a position about 180 degrees in relation to the bottom heating section 12. This is anticipated to be attained by positioning the top heating section 11 at a roughly perpendicular position, similar to the second position discussed above. Then, the top heating section 11 may be lifted such that the peg 73 travels up the channel 72 of the floating hinge 74. This action lifts the top heating section 11 from its resting point on the support structure 14. The top heating section 11 may then continue to be tilted towards the back of the electric grill 10 until it lays flat on the same plane as the bottom heating section 12. Just as in the other two positions, the top and bottom heating sections heat intensities may be adjusted separately while in this third position. Shown in FIG. 11, an alternative embodiment of the tilt mechanism is described below in connection with the embodiment of FIGS. 8-14.

This creates two cooking surfaces—the top cooking surface 31 and the bottom cooking surface 31—on which food may be placed. The two cooking surfaces may cook the same food or different foods. The cooking surfaces 31 may be the same or may be different in order to accommodate different foods or cooking activities. For example, the bottom heating section 12 may have a grill surface for cooking chicken, while the top heating section 11 has a sauté surface for sautéing vegetables. It should be noted that, additionally, while in the 180 degree open position, the top and bottom heating sections 11 and 12 can both be tilted to allow the separation of the excess grease, oils and juices from the food being cooked. Therefore, the 180 degree open position can become a, for example, 170 degree or 160 degree open position which allows the excess grease, oils and juices to separate from the food being cooked and collect in the drip tray 20.

Thus the top and bottom heating sections 11 and 12 may be utilized, when in the 180 degree open position, to cook the same food on both sections 11 and 12. Alternatively, the top and bottom heating sections 11 and 12 may be utilized, in this open position, to cook different types of foods, on different cooking surfaces 31 and at different heat intensities, as adjusted using the keypad 18 and as displayed on the digital read-out 17.

FIG. 5 illustrates a further feature of the electric grill 10. The top heating section 11, positioned in the first, or closed, position is lifted to the maximum height allowed by the slot 72 of the floating hinge 74 which may be around 3 inches. The tabs 50 are then extended by pressing the end of the tabs located on the external side of the support structure 14. The tabs 50 (one shown) are spring-loaded such that when pressed once, the tabs 50 extend toward the center of the electric grill 10. When pressed again, the tabs 50 retract back into the support structure 14. Each tab 50 extends far enough into the middle of the electric grill 10 such that the top heating section 11 may rest on top of the inwardly projecting tab end 50′ of each of them. The top heating section 11 has brackets 49 with grooves 51 on each side which interact with the suitably shaped inwardly projecting ends 50′ of the tabs 50 to hold the top heating section 11 in place. The tabs 50 also position the top heating section 11 roughly 3 inches above and parallel to the bottom heating section 12. Additional holes 53 can be provided to receive the tab ends 50′ so as to make slight adjustment to the inclination of the top heating section. It is anticipated that a set of tabs 50 could be incorporated to allow a variety of levels on which the top heating section 11 may rest. For example, a set of tabs 50 may be added to the support structure 14 at 3 inches, 2½ inches, 2 inches and so on to allow for greater flexibility in cooking. This creates a broil effect which may be used to broil food. As will be discussed below, the user input keypad 18 may be used to increase the heat intensity of the top heating section 11 and lower the heat intensity of the bottom heating section 12 to create the proper broiling effect.

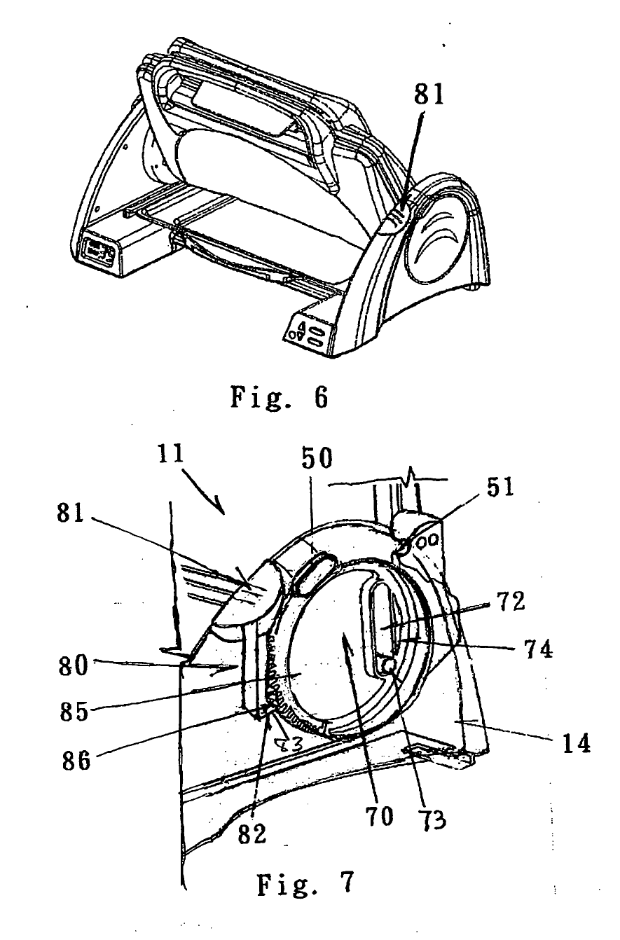

FIG. 6 illustrates still a further feature of the present invention. The top and bottom heating sections 11 and 12 may be adjustably tilted such that excess grease, oils and juices may separate from the food being cooked. The steeper the tilted angle, the more grease, oils and juices are drained from the food. Thus, by varying the angle of tilt, the user can determine the degree of grease, oils and juices the user wishes to drain from the food. Moreover, making the angle of tilt the maximum, about 60 degrees, creates a barbeque affect in that it allows as much of the excess grease, oils and juices to separate from the food as possible. This results in a grill which cooks food to be as healthy as the user wishes it to be, and, for example, to balance the flavor and the juiciness of meat with its lower fat and cholesterol content.

The user may adjust the angle of tilt of the top and bottom heating sections 11 and 12, preferably, by holding onto the two handles 15 and pressing and holding the button 81. By holding the button 81, the top and bottom heating sections 11 and 12 pivot freely at the hinge 70 since the button 81 unlocks the hinge 70 and allows the hinge 70 to pivot around the center of its circular shape. Once the desired angle of tilt is obtained, the user may release the button 81 and the tilt mechanism 80 locks the hinge 70 in place.

The electric grill 10 of the present invention preferably includes a tilt mechanism 80, as seen in FIG. 7, which serves to tilt the top and bottom heating sections 11 and 12 to the desired angle. The tilting mechanism 80 includes a rotatable gear-toothed wheel 85 fixedly attached to the hinge 70. The wheel 85 may have about 16 teeth 86 evenly spaced along the front side of the wheel. These teeth 86, as shown, create at least 13 different degrees of tilt. The tilting mechanism 80 locks the hinge 70 in place through the use of a rod 82 which interacts at its tip 83 with the gear-toothed wheel 85. The rod 82 is fixedly attached to the button 81 such that when the user presses the button 81, the tip 83 of the rod 82 disengages the teeth 86 on the wheel 85. When the button 81 is released, the rod 82 reengages the wheel 85 in between two teeth 86 and once again locks the hinge 70 in place. While the gear-toothed wheel/rod combination is a preferred embodiment, the tilting mechanism 80 is not limited to such design. It is equally possible to create a tilting mechanism using an electronic servo, a ratchet system or a friction system. The tilt mechanism 80 could tilt the grill in discrete positions, as with a gear wheel 85, or could be such that the degree of tilt is infinitely variable, as with a servo motor or friction system.

As seen in FIGS. 1-6, the preferred embodiment of the electric grill 10 of this invention includes a digital read-out 17 and user input keypad 18. The digital read-out displays cooking time, top heating section heat intensity and bottom heating section heat intensity. The cooking time is displayed in double digit minutes and double digit seconds, while the heat intensities of the top and bottom heating sections are displayed by a series of bars whereby a higher heat intensity is signified by a higher number of bars and a lower heat intensity is signified by a lower number of bars. If there are no bars next to the specified heating section, then that heating section is not producing heat. The top heating section heat intensity reading is across the top of the readout, while the bottom heating section heat intensity reading is along the bottom of the readout. Of course, any suitable heat read-out is contemplated.

Moreover, it is anticipated that the present invention allows for future upgrades such as pre-programmed modules or updates which may include pre-selected settings or cooking programs. For example, one of these pre-programmed updates can have a pre-programmed specific cooking set-up for cooking steak. By selecting the “steak” program, the cooking time and top and bottom heating sections heat intensities may be automatically set to properly cook steak in accordance with the pre-programmed module. The invention may be incorporated with a multitude of such pre-programmed modules for a variety of foods such as, but not limited to, chicken, fish, vegetables, pancakes, waffles, hamburgers and steak.

The user input keypad 18 provides an interface between the user and the electric grill 10. The user may input a desired grilling time and top and bottom heating section heat intensity. The cooking time may be inputted by adjusting the desired minutes and seconds for cooking, at the conclusion of which an alarm may sound. The top and bottom heating section heat intensities may be adjusted individually to be different or the same. For example, the user may simply adjust the number of bars next to “top” and “bottom” to acquire the desired heat intensity of each heating section.

Referring to FIG. 8, an embodiment of the grill 110 includes a lower cooking assembly 112 and an upper cooking assembly 114. The lower cooking assembly 112 includes a lower cooking plate 116 supported by a lower housing 118 and a forwardly projecting handle 120. The upper cooking assembly 114 includes an upper cooking plate 122 supported by an upper housing 124 and a forwardly projecting handle 126. The lower cooking plate 116 and upper cooking plate 122 can be made from a suitable aluminum alloy or other metal and is preferably coated with a non-stick coating as is known in the art. The cooking plates are electrically heated by a conventional heating element (not shown). The upper cooking plate 122 and lower cooking plate 16 contain circular depressions 128 to hold and contain various meats for cooking. The particular invention illustrated has five such depressions in the cooking plates, but the invention may contain any number of such depressions and these may vary in shape.

The upper and lower cooking plates 122 and 116 are pivotally connected along a horizontal axis 134 along the backside of the plates. The pivotal connection is made by means of a floating hinge described below. When the upper cooking assembly 114 is placed on top of the lower cooking assembly 112, a closed cooking chamber 136 is formed. The floating hinge allows the size and volume of the cooking chamber 36 to be varied, allowing for cooking of foods of varying thickness. FIG. 14 illustrates the upper and lower cooking plates spaced apart and parallel one another expanding the cooking chamber 360.

A raised ridge 130 runs along the horizontal axis 134 at the bottom edge of the lower cooking plate 116 and the upper cooking plate 122. Openings 131 in the raised ridges 130 allow oil, liquid and grease released from the meats during the cooking process to drain from the closed cooking chamber 136 to collect in a drip tray 132 located underneath the cooking chamber 136 for collection and disposal.

The cooking chamber 136 is supported by means of a right leg 138 and a left leg 140. A first pin 142 extends from the lower cooking assembly 112 to a slot 144 in the interior of the right leg 138 shaped to receive a first pin 142 pivotally supporting the upper assembly 114. A pin and slot in the left leg 140 is constructed as a mirror image of those in the right leg 138. The slots 144 in the interior of the legs 138 and 140 are located within a disc-like means 146 for rotating the connected lower cooking assembly 112 for movement about the horizontal axis 134. The pin 142 pivotally supports the upper assembly 114 with respect to the lower assembly 112. The slot 141 allows the upper assembly to lift away form the lower assembly. The pin 142 and slot 141 thus form a floating hinge allowing the cooking of thicker foods between parallel heated plates. This same construction is carried out on each side of the grill.

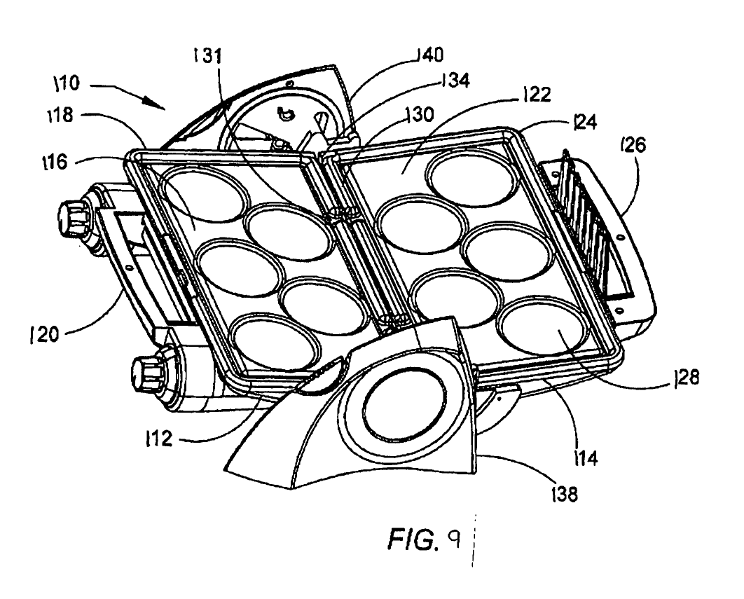

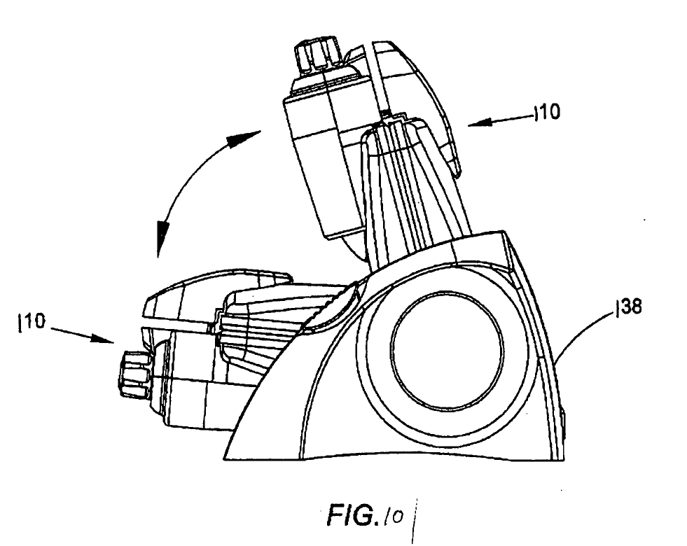

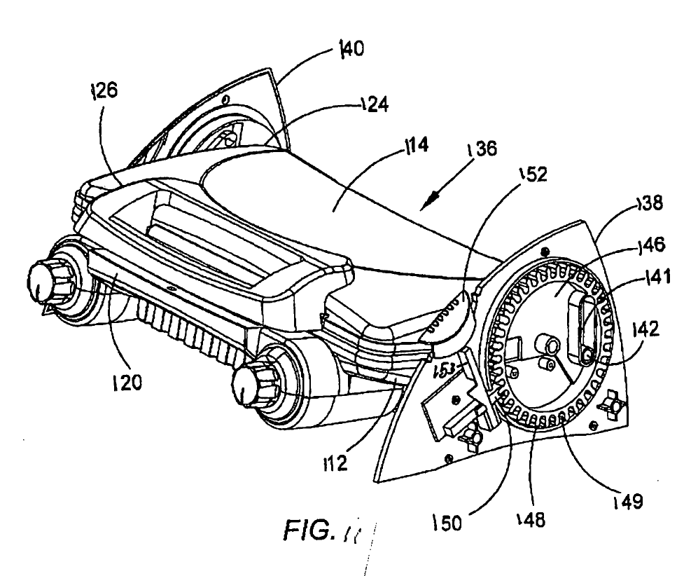

Generally, in use, the user will place the lower cooking assembly 112 in a horizontal position as depicted in FIG. 9 with the upper cooking assembly 114 in an open, horizontal position to allow the user to place the desired food onto the lower cooking plate 116 for cooking. The user will then close the upper cooking assembly 114 on top of the lower cooking assembly 112 to form the cooking chamber 136. The upper cooking assembly 114 and the lower cooking assembly 112 may be secured together by any conventional means. The user may also use the grill 110 in the open, horizontal position depicted in FIG. 9 to cook foods on a double-sized griddle or contact surface made up of the lower and upper cooking plates 116 and 122.

In the preferred embodiment depicted in FIG. 11, the openings in the interior of the leg 138 is an opening 144 with a circular gear 146 that rotates about a horizontal axis so that the cooking chamber 136 may be positioned at varying angles relative to the horizontal. The outside edge of the circular gear 146 contains alternating teeth 148 and grooves 149. A detent 150 has an end shaped to receive one of the teeth to secure the cooking chamber 136 in the selected position. A push button 152 forces a surface on a shaft 153 to drive the detent 150 out of engagement with the gear 146. The lower assembly can then be tilted as desired. The button 152 is released, the detent returns into engagement with the gear and the entire cooking chamber 136 is inclined as desired.

FIG. 10 illustrates placing the cooking chamber 136 at a position five degrees (5°) relative to horizontal to result in a very juicy food as only minimal fat and other juices will drain from the cooking chamber 136 through the openings 131 in the ridges 130 of the cooking plates 116 and 122 during the cooking process. At the other extreme, placing the cooking chamber 136 at a position seventy-five degrees (75°) relative to horizontal, as also shown in FIG. 10, will result in a drier, but healthier food that allows a majority of the fat and cooking juices to drain from the meat and into the drip tray 132. The cooking chamber 136 may also be placed at any position between five degrees (5°) and seventy-five degrees (75°) to achieve a cooking effect between a very moist and a very dry food.

Finally, as a safety measure, the upper cooking assembly 114 can include an automatic locking mechanism (not shown) that prevents the user from opening the cooking chamber 136 when the cooking chamber 136 is in an upright or inclined position relative to the horizontal. Upon return of the closed cooking chamber 36 to the horizontal position depicted in FIG. 9, the automatic locking mechanism will release, allowing the user to open the cooking chamber 136.

FIG. 3 illustrates placing the cooking chamber 36 at a position five degrees (5°) relative to horizontal to result in a very juicy food as only minimal fat and other juices will drain from the cooking chamber 36 through the openings 31 in the ridges 30 of the cooking plates 16 and 22 during the cooking process. At the other extreme, placing the cooking chamber 36 at a position seventy-five degrees (75°) relative to horizontal will result in a drier, but healthier food that allows a majority of the fat and cooking juices to drain from the meat and into the drip tray 32. The cooking chamber 36 may also be placed at any position between five degrees (5°) and seventy-five degrees (75°) to achieve a cooking effect between a very moist and a very dry food.

Finally, as a safety measure, the upper cooking assembly 14 contains an automatic locking mechanism (not shown) that prevents the user from opening the cooking chamber 36 when the cooking chamber 36 is in an upright or inclined position relative to horizontal. Upon return of the closed cooking chamber 36 to the horizontal position depicted in FIG. 2, the automatic locking mechanism will release, allowing the user to open the cooking chamber 36.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An electric grill, comprising:
a support structure;
a top heating section having a top cooking surface and a bottom heating section having a bottom cooking surface, said sections being connected to the support structure and at least one section being pivotally associated with the support structure to move between a closed position at which the cooking surfaces are facing one another and an open position at which the surfaces are at an angle to one another that is approximately 180 degrees; and
said support structure including a tilting mechanism, said tilting mechanism supporting said sections in a plurality of angular positions.

2. The electric grill of claim 1, wherein the tilting mechanism comprises a gear allowing releasable fixation of the top and-bottom heating sections at a number of discrete angular positions.

3. The electric grill of claim 2, wherein the tilting mechanism is a gear-tooth wheel in conjunction with a rod, a portion of which fits within two teeth of the gear, such that when the rod engages the wheel the top and bottom heating surfaces are locked in place and when the rod is disengaged the combination of the top and bottom heating surfaces can move freely.

4. The electric grill of claim 3, wherein the rod engages and disengages the wheel by a push button.

5. The electric grill of claim 1, wherein the tilting mechanism allows for angular positioning at discrete positions between 0 and 60 degrees.

6. The electric grill of claim 1, wherein the sections are hinged together by at least one hinge.

7. The electric grill of claim 1, wherein the sections are hinged together by two hinges separated from one another which allows for grease, oils and juices from the food being cooked to drip off of the bottom heating section from between the two hinges.

8. The electric grill of claim 6 or 7, wherein the tilting mechanism and the hinge together attach to the top and bottom heating sections at the same point.

9. The electric grill of claims 6 or 7, wherein the at least one hinge allows the top heating section to separate from the bottom heating section to a predetermined distance.

10. The electric grill of claim 1, further comprising a removable drip tray.

11. The electric grill of claim 6, wherein the at least one hinge comprising a channel and peg where the peg slides up and down the channel such that said top heating section may be lowered towards the bottom heating section or may be separated away from the bottom heating section while said sections remain parallel to one another.

12. The electric grill of claim 11, further comprising a tilting mechanism comprising a gear allowing releasable fixation of the top and bottom sections at a number of discrete angular positions.

13. A method of using an electric grill, comprising:
raising a top heating section to a position pivoted away from a bottom heating section;
placing food on the bottom heating section;
lowering the top heating section such that the top heating section is parallel to the bottom heating section;
tilting the top and bottom heating sections to a discrete angular position such that grease, oils and juices may be separated from the food being cooked.

14. An electric grill comprising:
a top heating section having a top heating surface;
a bottom heating section having a bottom heating surface;
pivotal mounting means supporting the bottom heating section at selected positions from horizontal to inclined at one or more angles to the horizontal;
at least one floating hinge interconnecting the top heating section and the bottom heating section and allowing the top heating section to be pivoted toward and away from the bottom heating section and displaced adjacent to and further remote from the bottom heating apparatus so as to accommodate foods of various thickness.

15. An electric grill, comprising:
(a) an upper cooking assembly comprised of an upper cooking plate supported by an upper housing and a forwardly projecting handle;
(b) an automatic locking mechanism on the upper cooking assembly;
(c) a lower cooking assembly comprised of a lower cooking plate supported by a lower housing and a forwardly projecting handle;
(d) a foldable hinge for connecting the upper and lower cooking assemblies at the backside of said assemblies along a horizontal axis;
(e) a drip tray located underneath the upper and lower cooking assemblies;
(f) a right leg for supporting said assemblies;
(g) a left leg for supporting said assemblies;
(h) a first pin extending from the lower cooking assembly to an opening in the right leg;
(i) a second pin extending from the lower cooking assembly to an opening in the left leg; and
(j) said pins located within a means for rotating the pins and connected lower cooking assembly at various angles relative to horizontal.
